(19) United States
(12) Patent Application Publication
(10) Pub. No.: US 2020/0182485 A1
(43) Pub. Date: Jun. 11, 2020

(54) STEAM COOKING DEVICE

(71) Applicant: BSH Hausgeräte GmbH, Munich (DE)

(72) Inventors: Ludovic Ball, Sessenheim (FR); Sebastian Frey, Königsbach-Stein (DE); Manfred Hintermayer, Karlsruhe (DE)

(21) Appl. No.: 16/641,267

(22) PCT Filed: Jul. 25, 2018
(86) PCT No.: PCT/EP2018/070109

§ 371 Date: Feb. 24, 2020

(30) Foreign Application Priority Data
Aug. 25, 2017 (DE) 10 2017 214 928.0

(51) Int. Cl. F24C 15/32; F24C 15/00; A47J 27/04; A21B 3/04

(52) U.S. Cl. CPC F24C 15/327; F24C 15/003; A47J 2027/043; A21B 3/04; A47J 27/04

(57) ABSTRACT

A steam cooking appliance includes a cooking chamber, a water supply unit including a removable water tank having a filling opening, and an evaporator unit connectable to the water supply unit. The water tank includes in an installed position a front side facing a user, a rear side opposite the front side, and a closure element for closing the filling opening. The closure element is configured to form at least in part the front side or the rear side of the water tank. The evaporator unit is configured to evaporate water from the water supply unit to generate steam for supply into the cooking chamber.

### BACKGROUND OF THE INVENTION

The invention relates to a steam cooking appliance comprising a water supply unit which has a removable water tank which, in the installed position, has a front side facing the user and a rear side opposite the front side and a closure element for closing the filling opening of said water tank, and an evaporator unit which can be connected to the water supply unit and by means of which water from the water supply unit can be evaporated and the steam generated in the evaporator unit can be provided into the cooking chamber of the steam cooking appliance.

### PRIOR ART

Ovens are known which also offer the possibility of preparing food to be cooked by generating steam in the cooking chamber. During preparation, bursts of steam are generated which are conducted into the cooking chamber or are first generated therein. For this purpose, a container for storing water is required. In known appliances, this can be arranged in the region of the control panel of the oven and can be removed therefrom. In conventional embodiments, removal can be relatively complicated and cumbersome. Furthermore, the filling of the water tank is often difficult.

EP 2 463 585 A1, for example, discloses a water tank for a steam cooking appliance, having a container for receiving the water, wherein a front cover is arranged on the container as a panel which is arranged so as to be moveable relative to the container.

The description of the prior art is provided to facilitate understanding of the background of the present invention, and may include items outside the prior art known to the average person skilled in the art.

### Object Underlying the Invention

It is an object of the present invention to provide a steam cooking appliance which is improved compared with the prior art and that eliminates the aforementioned disadvantages while maintaining the advantages achieved from the prior art.

### Solution According to the Invention

The solution of the set object is achieved by a steam cooking appliance with the features of claim 1. According to the invention, this can be achieved in a steam cooking appliance according to the preamble of claim 1 in that the closure element forms the front side or the rear side of the water tank, at least in sections.

A steam cooking appliance is to be understood as meaning any household appliance which cooks food to be cooked introduced into a cooking chamber by means of steam and/or improves the result of a food to be cooked. It goes without saying that the steam cooking appliance can be both a cooking appliance, for example an oven, with a steam function, in which in addition to the steam produced there are also further heat sources in the form of heating elements, for example, and also a steam cooking appliance which uses only steam for heating/cooking food to be cooked.

In addition to the above-mentioned water tank, the water supply unit can also have further components which may be required for supplying an evaporator unit with water. These include, for example, a water supply unit which connects the water tank to the evaporator unit, and all types of lines and/or line systems as well as connecting and/or connection elements. The water supply unit has means for coupling to the water tank on a first end section and means for coupling to the evaporator unit on a second end section. In particular, the water supply unit is designed in such a way that it enables a water circuit according to the bird bath principle. This bird bath principle is well known to the person skilled in the art, and therefore a detailed description thereof can be omitted.

The installed position of the water tank is to be understood as meaning the position in which the water tank is accommodated in the steam cooking appliance, for example in a holder provided for this purpose, and in particular is ready for operation. As a result, the front side of the water tank facing a user forms a visible part of an operating panel. The front side is formed on a first end section of the water tank and the rear side of the water tank is formed on an end section opposite the first end section.

During operation, the water stored in the water tank can be supplied to an evaporator unit arranged in the steam cooking appliance. Steam can be generated by means of the evaporator and made available in the cooking chamber of the steam cooking appliance. The function of an evaporator unit is well known to the person skilled in the art, and therefore a detailed description thereof can be omitted.

The closure element closes a filling opening of the water tank for filling with water, in particular by a water tap, and in particular in such a way that no more water can escape when the water tank is in the installed position. Due to the fact that the closure element forms the front side or the rear side of the water tank at least in sections, a positive appearance of the steam cooking appliance can be realized as the respective side of the water tank can be advantageously integrated into the design of the appliance without having to compromise in terms of user comfort during removal/filling of the water tank. In other words, from the design point of view, almost complete integration of the water supply unit or of the water tank into a panel support or a control panel of the steam cooking appliance is possible.

From a design point of view and for cleaning purposes, it is particularly desirable here that the front side or the rear side of the water tank is essentially flush with the front surface of the control panel. That is, the front or rear side of the water tank is integrated into the control panel in the installed position thereof in such a way that there are no disturbing components which protrude or are set back with respect to a front surface of the control panel in the direction of a user. As a result, a homogeneous appearance can be realized in an advantageous manner. The closure element or the front side of the closure element is handle-free and is in particular flat, so that a good integration into the control panel can be realized.

According to the invention, it is provided that the closure element forms the front side or the rear side of the water tank, at least in sections. This is to be understood as meaning that the front surface of the closure element facing a user of the steam cooking appliance forms at least part of the front or rear side. Thus, it would also be conceivable for the front surface of the closure element to have a surface dimension which is smaller than the surface dimension of the cross-sectional area of the water tank, wherein the front surface and the cross-sectional area are essentially parallel to one another. However, it is also conceivable that the front surface has a surface dimension that is greater than that of the cross-sectional area. This could be advantageous in particular if a diameter of the water tank or its cross-sectional area is smaller than the diameter or the cross-sectional area of the closure element to be integrated into the control panel of the steam cooking appliance. A water tank can thus be integrated into the control panel, the closure element of which has, for example, the same optical system and/or size and/or shape as an adjacent operating toggle of the steam cooking appliance.

According to the invention, it is provided that the closure element can form the front side or the rear side of the water tank. If the closure element forms the front side of the water tank at least in sections, then the front surface of the closure element faces the user in the installed position of the water tank. In contrast, if the closure element at least in sections forms the rear side of the water tank, the front surface of the closure element faces away from the user and thus is not visible to the user. Thus, the user standing in front of the steam cooking appliance would only be able to see the bottom or bottom area, whereas the rear side of the water tank formed by the closure element is covered in the appliance. It will be understood by the average person skilled in the art that in the latter case, means/components are provided in the closure element that are configured to connect/couple to the water supply unit. Thus, the difference between the two variants described is only that the attachment of the closure element takes place in reverse. The filling opening of the water tank is located in particular on the opposite side of an outlet opening thereof.

Advantageous embodiments and developments which can be used individually or in combination with one another are the subject matter of the dependent claims.

According to an embodiment of the invention, the closure element can be fastened to a main body of the water tank by means of a bayonet or screw closure. As a result, the water tank can be comfortably and quickly closed.

Preferably, a main body of the water tank has an essentially elongated, preferably cylindrical, more preferably circular-cylindrical design, for which reason the filled water is stored in this (main) part of the water tank. This would have the advantage that an improved optical result and improved handling during the filling of the water tank can be achieved on the one hand in relation to the operating toggle arranged next to the water tank in/on the control panel of the steam cooking appliance. This means that the user standing in front of the steam cooking appliance would be able to get the impression that the inserted water tank, i.e. in the installed position, is optically an operating toggle. It is furthermore preferred that markings concerning the filling level are provided on the essentially transparent main body of the water tank. The main body may be made of plastic in a non-limiting manner. It is understood that the entire water tank can be made of plastic. However, it is also conceivable that the closure element has a different material than that of the main body. The closure element can be attached to a first end section of the main body, for example by one of the above-mentioned closure types, the main body having an embodiment corresponding to the type of closure, for example a thread, part of a bayonet closure or the like on the first end section. On the second end section of the main body opposite the first end section, an outlet opening is provided, in which a valve is attached, which will be described later.

For better sealing, the closure element and/or the main body on a connecting section can have a seal, in particular a rubber seal. An improved sealing effect can thereby be achieved. It can be provided, for example, that the seal has an outer diameter which essentially corresponds to an inner diameter of the closure element. In the closed state of the closure element, the seal essentially rests against an end-face front section of the main body or its outer casing surface. The seal can be inserted loosely into the closure element or can be firmly connected thereto. In the case of a one-piece/integral design of the closure element and the seal, a loss of the loose seal could be prevented.

Preferably, the rubber seal is designed as an O-ring which, in a closed position of the closure element, is pressed against a sealing edge of the main body by a spring. A further improved sealing effect can thus be achieved. As a spring, any type of spring, such as a coil spring, spiral spring or the like, may be used in the entire disclosure in a non-limiting manner. It is particularly preferred that the O-ring is arranged on a seal support, in particular a pot-shaped seal support, and that the spring is arranged between a closure cover of the closure element and the seal support. This arrangement has the advantage that the seal in the form of the O-ring is pressed in a spring-loaded manner against the sealing edge formed on the main body, for which reason the sealing effect is further intensified. Moreover, it is provided that the seal support is designed in such a way that it is attached to the closure cover, for example by means of a catch. As a result, a closure element in the form of a compact structural unit can be produced, which has the closure cover, the seal, the seal support and the spring arranged between the seal support and the closure cover. In this connection, a circumferential groove/depression is provided on the seal support on/into which groove/depression the O-ring can be attached. The groove is arranged in particular on an end section facing the main body of the water tank.

In a further embodiment it is provided that the closure element has a cover cap which, at least in sections, forms the front side of the water tank. This makes it possible to achieve a specific adaptation to the existing design of the steam cooking appliance. This relates in particular to the instances in which different panel materials such as, for example, glass, metal or the like, are used. Moreover, by means of a cover cap integrated into the appearance of the steam cooking appliance, it is possible to cover different design lines of a household appliance manufacturer. In this case, it is particularly preferred if the closure element or the closure cover has an interface/connection which corresponds to the interface/connection of the operating toggle. In the case of the attachment of the cover cap, it is likewise provided that the front side of the water tank is flush with the front surface of the control panel.

For fluidic coupling to the evaporator unit, the water tank has a valve unit for coupling. This valve unit serves for fluidic coupling and is suitable for filling with water. As a rule, the coupling takes place by means of a water supply unit which operates according to the bird bath principle and which represents the connecting element between the water tank and the evaporator unit. The valve unit has, in a non-limiting manner, a valve or a valve device in the form of an exhaust valve which allows the water stored in the water tank to run off in the direction of the evaporator unit as soon as the valve unit is coupled or connected to a connection element or docking connection of a water supply unit. The valve unit is provided in/on an outlet opening formed in the main body of the water tank. The water supply unit has, in a non-limiting manner, a line system for supplying the water to the evaporator unit, wherein the connection element or the docking connection is then provided on the line system. As mentioned at the beginning, the line system operates according to the bird bath principle. In this case, the valve unit opens only in the completely inserted state of the water tank.

In a further embodiment of the present invention, provision is made for the water supply unit to have a receiving unit for receiving the water tank, wherein the receiving unit is attached in particular to a panel support of the steam cooking appliance. The receiving unit preferably has a lower and an upper housing shell and is preferably made from a plastic. It is particularly advantageous if the receiving unit has an interface/connection which corresponds to the interface/connection of a toggle pot which is likewise arranged on the panel support. As a result, advantages can be achieved both in production and assembly as different openings/punch-throughs do not have to be produced in the panel support for the receiving unit. A microswitch by means of which it can be detected whether the water tank is completely coupled, can preferably be arranged, in particular on an outer side of the receiving unit. For example, in the event of a faulty, i.e. incomplete coupling of the water tank by the microswitch to a control of the steam cooking appliance, a signal could be output via the faulty coupling so that in turn a corresponding message could be output to a user.

For better adaptation to the water tank, it may be preferred that the receiving unit has an essentially elongated, preferably cylindrical, more preferably circular-cylindrical design. It is understood by the average person skilled in the art that in the case of a receiving unit formed by an upper and lower housing shell, both housing shells can each have the shape of a corresponding semi-cylinder, for example. Moreover, it goes without saying that the elongated, preferably cylindrical or circular-cylindrical construction does not have to extend over the entire length of the receiving unit, but rather only a certain or predetermined section has this shape. In particular, the length of this section corresponds to 50%, preferably 60% and more preferably 70% of the total length in the direction of extension of the receiving unit.

According to a further embodiment of the present invention, the receiving unit comprises an adapter part having a first connection means for the fluidic coupling, in particular by latching, of the water tank in an operating position on the one hand and a second connection means for coupling to the evaporator unit on the other hand. This enables simple and secure coupling between the water tank and the evaporator unit as well as of the water tank in the receiving unit. The first connection means can in particular be formed by means of a latching spring or a latching element, in that a latching section or latching projection formed on the main body of the water tank is latched in the completely inserted state of the water tank. The second connection means can in particular be a docking connection or connecting piece, to which, for example, a hose or a line of a water supply unit is attached for coupling to the evaporator unit. The adapter part can be fixed to the receiving unit by means of a securing spring attached to the receiving unit.

According to yet another embodiment, the adapter part comprises a securing part with the first connecting means and a connecting part with the second connecting means, wherein the connecting part and the securing part can be formed by two separate components. As a result of this two-part design, it is possible, for example, to provide the arrangement of additional components, such as, for example, a seal/rubber seal which is arranged between the securing part and the connecting part and can be replaced. The securing part can, for example, on a first end section, have the first connecting means in the form of latching lugs/latching hooks or the like and, at the second end section which lies opposite the first end section, have a coupling element for coupling/connecting to the connecting part in the form of latching projections, latching lugs or the like. The connecting part, which is designed to couple the water tank to the evaporator unit via a water supply unit, can have, on a first end section, the second connection element in the form of a docking connection or the like and, at the second end section which lies opposite the first end section, likewise a coupling element which can be brought into engagement with the coupling element of the securing part or can be latched thereto, in the form of latching projections or the like.

The adapter part is preferably mounted so as to be displaceable essentially in an actuating direction of the water tank in a bearing section formed in the receiving unit, as a result of which, for example, a mechanism for inserting and removing the water tank can be realized. The insertion and removal can be provided both manually and in the form of an electric motor. In the case of the electric motor, for example, a button could then be provided in the control panel in order to start the insertion and/or removal of the water tank. The actuating direction of the water tank corresponds to the direction in which the water tank can be inserted into and removed from the receiving unit.

It is particularly preferred if the adapter part has a slotted guide and spring force is applied essentially in the actuating direction by a spring, wherein a sliding block, which is guided in a retaining clip, engages in the slotted guide. As a result, a unit/arrangement for insertion and/or removal of the water tank can be realized in a simple manner. It is understood by the average person skilled in the art that the slotted guide can also be formed in the securing part or the connecting part. In particular, a so-called cardioid is provided as a slotted guide. The provision of a spring/compression spring which acts on the adapter part with a spring force has the advantage that the unit/arrangement and thus the water tank can be brought into firmly defined positions and no intermediate positions can arise. According to a development, the spring can be supported on a securing spring or a securing bracket which is arranged on the receiving unit, preferably on the lower housing shell. The sliding block is preferably guided in a longitudinal slot of the retaining clip, which is preferably arranged on the lower housing shell. The longitudinal slot runs essentially perpendicular to a main extension direction of the water tank or to the aforementioned actuating direction thereof.

According to an embodiment of the invention, the water tank can be removed from the steam cooking appliance by means of a push-push unit. However, any other principle suitable for inserting and removing the water tank may also alternatively be used for this purpose as well. For example, it is also possible to provide an unlocking mechanism which is actuated, for example, by an unlocking button mounted on the control panel. In this case, actuation of the button would lead to an at least partial ejection of the water tank. The locking in the receiving unit could then be realized, for example, by inserting and locking the same by the user.

When using a push-push unit, there can be three essential states without restriction. First, a retracted state corresponding to an operating state of the water tank in which the water tank is fully docked so that water can be discharged from the water tank in the direction of the evaporator unit. In this state, the front side of the water tank is substantially flush with the front surface of the control panel. A second state may correspond to a depressed state after actuation of the push-push unit. In this case, the front side of the water tank is pressed until the water tank reaches an end position on the basis of the sliding block guided in the slotted guide. In this depressed state, the front is set back with respect to the front surface. The offset to the rear, that is to say, in the direction of insertion of the water tank, can, for example, be approximately 3 mm. A third state may correspond to an extended state of the water tank. The extended state is reached after removal of the force generated by the pressing onto the front side of the water tank until the water tank reaches a further end position on account of the sliding block engaging in the slotted guide. In this extended state, the front side of the water tank projects in the direction of a user with respect to the front surface of the control panel. The corresponding offset to the front can be approximately 18 mm, so that there is a sufficiently large area for grasping and removing the water tank.

The steam cooking appliance according to the invention has a simple water supply unit with a water tank which is easy to fill and is thus less susceptible to malfunction than the appliances known from the prior art. Furthermore, the specific embodiment of the completely removable water tank simplifies the filling process as the water tank can be filled with the aid of a normal water tap. After a filling process, the water tank can be closed by the closure element and introduced into the receiving unit provided on the steam cooking appliance. It is also conceivable here that an anti-rotation safeguard is provided on the water tank and/or the receiving unit.

Further features of the invention emerge from the claims, the figures and the description of the figures. The features and feature combinations mentioned above in the description and the features and feature combinations mentioned below in the description of the figures and/or shown in the figures alone can be used not only in the respectively specified combination, but also in other combinations or in isolation, without departing from the scope of the invention.

### BRIEF DESCRIPTION OF THE DRAWINGS

The above and other features of the present invention will now be described in detail with reference to certain exemplary embodiments thereof, which are illustrated by the accompanying drawings, and which are merely for illustration purposes hereinafter, and thus are not intended to be limiting of the present invention. The drawing shows:

FIG. 1 a perspective view diagrammatically illustrating a household appliance in the form of a steam cooking appliance according to a first exemplary embodiment of the present invention;

FIG. 2 a perspective view which diagrammatically illustrates a section of the steam cooking appliance of FIG. 1 without an upper housing part;

FIG. 3 a diagrammatic exploded view of individual components of the steam cooking appliance according to the exemplary embodiment of the present invention;

FIG. 4 a perspective view which diagrammatically illustrates some of the components illustrated in FIG. 3 in an assembled state;

FIG. 5 a diagrammatic exploded view of a closure element of a steam cooking appliance according to a second exemplary embodiment of the present invention;

FIG. 6 a diagrammatic sectional view along the section plane Iv-Iv from FIG. 5, the closure element being mounted on a main body of the water tank.

It should be noted that the accompanying drawings are not necessarily to scale and represent a somewhat simplified illustration of various preferred features which serve to illustrate the principles of the invention. The specific structural features of the present invention, as disclosed herein, including, for example, specific dimensions, orientations, installation locations and shapes, are partially determined by the dedicated application and the working environment.

In the figures, identical or functionally identical elements are provided with the same reference characters.

### DETAILED DESCRIPTION OF THE FIGURES

Exemplary embodiments of the present invention are explained in detail hereinafter with reference to the accompanying drawings.

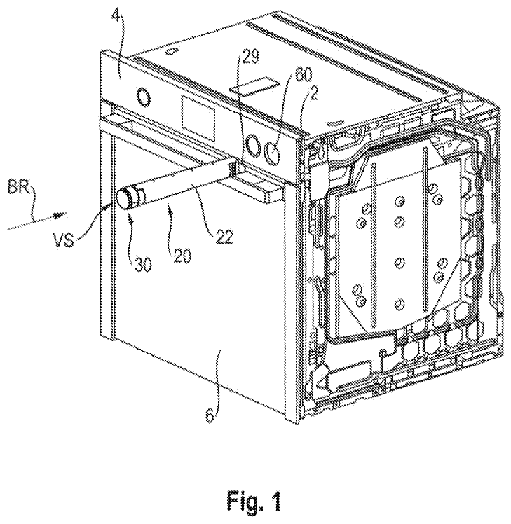

FIG. 1 shows a simplified diagrammatic illustration of a perspective view of a household appliance in the form of a steam cooking appliance according to a first exemplary embodiment of the present invention. The steam cooking appliance has a cooking chamber (not shown) located behind a door 6 into which food to be cooked can be introduced. During operation of the steam cooking appliance, food introduced into the cooking chamber is cooked by steam introduced into the cooking chamber. The steam is generated by an evaporator unit (not shown).

The steam cooking appliance has a control panel 4 which is mounted on a panel support 2 and is arranged above the door 6. In a right-hand region of the control panel 4, a water tank 20 can be introduced into a receiving unit 60 for coupling to the evaporator unit. The water tank 20 has a main body 22 which is closed at the front side VS by a closure element 30 in the state shown. The main body 22 has an elongated circular-cylindrical shape. An outlet opening 29 is formed on an end section of the main body 22 facing the steam cooking appliance. In the actuating direction BR, the water tank 20 can be inserted into and removed from the receiving unit 60 in a non-destructive and reversible manner in order to achieve an operating position. The liquid medium provided for evaporation in the form of water is stored in the water tank 20.

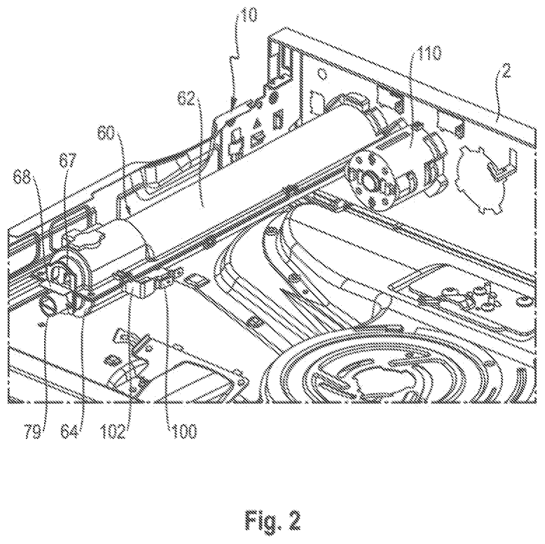

FIG. 2 is a perspective view diagrammatically illustrating a section of the steam cooker of FIG. 1 without an upper housing section of the steam cooker. A two-part receiving unit 60 of a water supply unit 10 is mounted on the rear side of the panel support 2 on a recess formed in the panel support 2. It can be clearly seen that a connection of the receiving unit 60 to the panel support 2 corresponds to a connection of a toggle pot 110, for which reason only one type of recess for the receiving unit 60 and the toggle pot 110 is provided in the panel support 2.

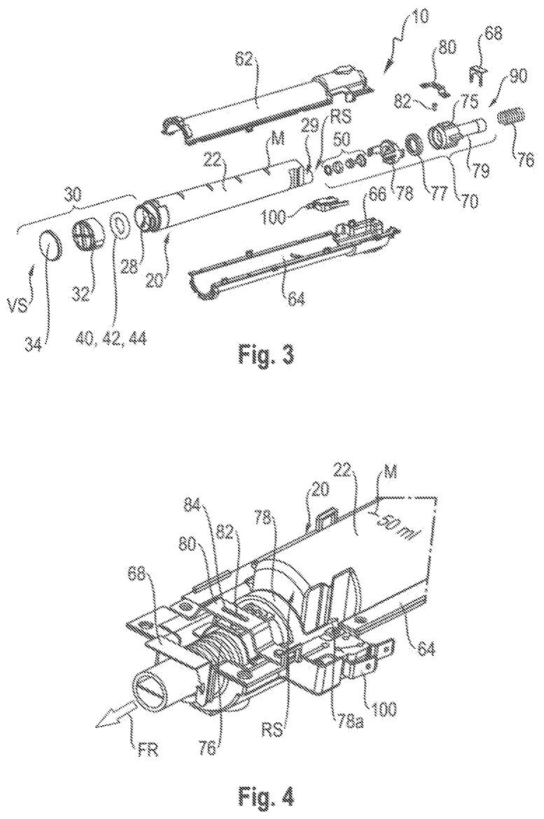

The receiving unit 60 is formed from an upper housing part 62 and a lower housing part 64. In the assembled state, in which the upper housing part 62 and the lower housing part 64 are fastened to one another, the receiving unit 60 has, on a rear end region with respect to the panel support 2, a bearing section (66 in FIG. 3) which is open in a direction facing away from the panel support 2. In the opening 67 of the bearing section 66, a connecting part 79 can be seen which forms part of an arrangement for coupling the water tank (not shown) to the evaporator unit (not shown). Fastened to the opening 67 is a securing spring 68, on which the connecting part 79 is supported via a compression spring (not shown). On a mounting section 102 attached to the housing outer wall of the receiving unit 60, a microswitch 100 is provided in the region of the bearing section 66 in order to detect an operating position of the water tank.

FIG. 3 shows a diagrammatic exploded view of individual components of the water supply unit 10 of the steam cooking appliance according to the first exemplary embodiment of the present invention. In detail, the closure element 30, the main body 22 of the water tank 20, a valve unit 50 arranged in the outlet opening 29 of the main body 22, the receiving unit 60 formed from the upper housing part 62 and the lower housing part 64, and an adapter part 70 as well as further components for fastening and/or securing these components are shown. In the exemplary embodiment shown, the closure element 30 comprises a closure cover 32 and a cover cap 34 which is attached to the closure cover 32 on the front side. A rubber seal 42 can be inserted into the closure cover 32 so that the main body 22 can be tightly closed by the closure cover 32. In the example shown, the closure cover 32 can be fastened to the main body 22 by means of a bayonet closure.

A plurality of markings M, with which the quantity of water can be read off during the filling of the water tank 20, is located on the main body 22. At an end section opposite the closure element 30, an outlet opening 29, in which the valve unit 50 is arranged, is formed on the main body 22 of the water tank 20. The valve unit 50 is designed as an exhaust valve.

As can be seen from FIG. 3, the adapter part 70 is formed by a securing part 78, a connecting part 79 and an interjacent sealing part 77. At its section facing the water tank 20, the securing part 78 has, as a first connecting means, two latching elements in the form of latching lugs which can be brought into engagement with corresponding latching elements of the water tank 20 or of the main body 22. On the other section of the securing part 78, which faces the connecting part 79, there are likewise two connecting elements with the aid of which the securing part 78 can be fastened to the connecting part 79. For this purpose, corresponding connecting elements are provided on the connecting part 79 on a first section facing the securing part 78. A connection piece is formed as a second connection means for coupling to the evaporator unit on the second section of the connecting part 79 opposite the first section.

In the assembled state, a compression spring 76 supported on a securing spring 68 is provided in order to apply a spring force to the adapter part 70 in the direction of the water tank 20. A slotted guide in the form of a cardioid, in which a sliding block 82 can be brought into engagement, is formed on a section of the connecting part 79. The sliding block 82 is guided in a retaining clip 80.

FIG. 4 shows a perspective view diagrammatically illustrating some of the components illustrated in FIG. 3 in an assembled state. FIG. 4 clearly shows the adapter part 70 formed by the securing part 78 and the connecting part 79. Furthermore, it can be seen that a longitudinal slot 84, in which the sliding block 82 is guided, is formed on the retaining clip 80. FIG. 4 shows the operating state in which the water tank 20 is completely locked in its end position with the securing part 78 and thus the water stored in the tank can be supplied to the evaporator unit through the opened exhaust valve in a flow direction FR. Furthermore, it can be seen from FIG. 4 that a latching hook 78a formed on the securing part 78 engages with a latching projection formed on the main body 22 of the water tank 20 so that the water tank 20 is held stably in its operating position in combination with the spring force generated by the compression spring 76 on the water tank 20.

FIG. 5 shows a diagrammatic exploded view of a closure element of a steam cooking appliance according to a second exemplary embodiment of the present invention. In contrast to the first exemplary embodiment, the closure element 30 is formed from a closure cover 32, a cover cap 34 attached to the front side of the closure cover 32, a seal support 48 with an O-ring 44 mounted thereon, and a spring 46 arranged between the seal support 48 and the closure cover 32. The O-ring 44 is attached to the seal support 48 on the circumferential side on an end section facing away from the closure cover 32. On the section facing the closure cover 32, the seal support 48 has a plurality of latching elements with which the seal support 48 is fastened to the closure cover 32, with the interjacent spring 46. The spring 46 is designed as a compression spring, so that it is supported on the one hand on the closure cover 32 and on the other hand applies a spring force to the seal support 48.

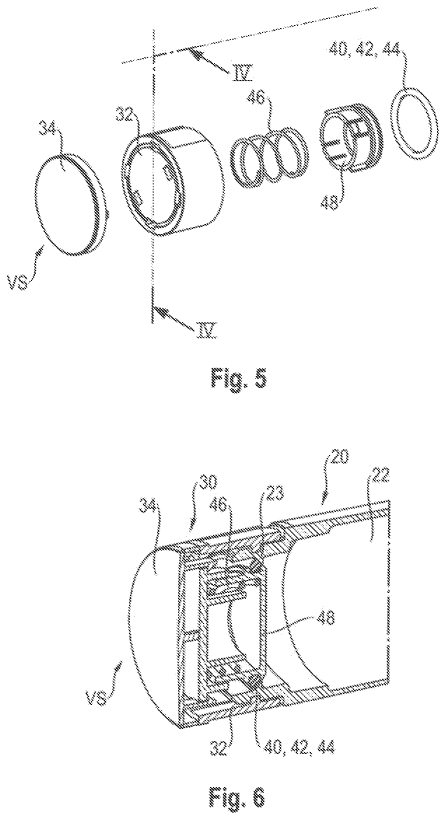

FIG. 6 shows a diagrammatic sectional view along the section plane Iv-Iv from FIG. 5, wherein the closure element is mounted on a main body of the water tank. As can be seen from FIG. 6, in the state in which the closure element 30 is screwed to the main body 22 of the water tank 20, the O-ring seal 44 is pressed against the sealing edge 23 formed on the main body 22 by the spring force produced by the spring 46. The sealing edge 23 is formed circumferentially in the interior of the main body 22. The sealing edge 23 is formed on the circumferential side in the interior of the main body 22. Furthermore, it can be seen in FIG. 6 that on its end section facing the closure element 30, the main body 22 of the water tank 20 has a diameter which is smaller than the diameter outside the end section. The outer diameter of the closure element 30 essentially corresponds to the outer diameter of the main body 22 of the water tank 20. The inner diameter of the closure element 30 essentially corresponds to the outer diameter of the end section of the main body 22 facing the closure element 30.

### LIST OF REFERENCE CHARACTERS

2 Panel support
4 Panel
6 Door
10 Water supply unit
20 Water tank
22 Main body
23 Sealing edge
24 Front side
26 Rear side
28 Filling opening
29 Outlet opening
30 Closure element
32 Closure cover
34 Cover cap
40 Seal
42 Rubber seal
44 O-ring
46 Spring
48 Seal support
50 Valve unit
60 Receiving unit
62 Upper housing part
64 Lower housing part
66 Bearing section
67 Opening
68 Securing spring
70 Adapter part
75 Slotted guide
76 Compression spring
77 Sealing part
78 Securing part
78a Latching hook
79 Connecting part
80 Retaining clip
82 Sliding block
84 Longitudinal slot
90 Push-Pull unit
100 Microswitch
102 Mounting section
110 Toggle pot
BR Actuating direction
FR Flow direction
M Marking
VS Front side
RS Rear side

1-15. (canceled)

16. A steam cooking appliance, comprising:
a cooking chamber;
a water supply unit including a removable water tank having a filling opening, said water tank including in an installed position a front side facing a user, a rear side opposite the front side, and a closure element for closing the filling opening, said closure element configured to form at least in part the front side or the rear side of the water tank; and
an evaporator unit connectable to the water supply unit and configured to evaporate water from the water supply unit to generate steam for supply into the cooking chamber.

17. The steam cooking appliance of claim 16, wherein the water tank includes a main body, said closure element being configured for fastening to the main body of the water tank via a bayonet or screw closure.

18. The steam cooking appliance of claim 16, wherein the water tank includes a main body having an essentially elongated configuration.

19. The steam cooking appliance of claim 18, wherein the main body has a cylindrical configuration or a circular-cylindrical configuration.

20. The steam cooking appliance of claim 17, wherein at least one of the closure element and the main body has a connecting section, and further comprising a seal placed on the connecting section.

21. The steam cooking appliance of claim 20, wherein the seal is a rubber seal.

22. The steam cooking appliance of claim 21, wherein the rubber seal is an O-ring, and further comprising a spring configured to press the O-ring in a closed position of the closure element against a sealing edge of the main body.

23. The steam cooking appliance of claim 22, wherein the closure element includes a closure cover, and further comprising a seal support for arrangement of the O-ring, said spring being arranged between the closure cover of the closure element and the seal support.

24. The steam cooking appliance of claim 23, wherein the seal support is pot-shaped.

25. The steam cooking appliance of claim 16, wherein the closure element includes a cover cap which at least in part forms the front side of the water tank.

26. The steam cooking appliance of claim 16, wherein the water tank includes a valve unit for coupling to the evaporator unit.

27. The steam cooking appliance of claim 16, further comprising a panel support, said water supply unit including a receiving unit for receiving the water tank, said receiving unit being attached to the panel support.

28. The steam cooking appliance of claim 27, wherein the receiving unit has an essentially elongated configuration.

29. The steam cooking appliance of claim 27, wherein the receiving unit has a cylindrical configuration or a circular-cylindrical configuration.

30. The steam cooking appliance of claim 27, wherein the receiving unit includes an adapter part with a first connection for fluidic coupling of the water tank in an operating position, and a second connection for coupling to the evaporator unit.

31. The steam cooking appliance of claim 30, wherein the first connection is coupled to the water tank by latching.

32. The steam cooking appliance of claim 30, wherein the adapter part includes a securing part to form the first connection and a connecting part to form the second connection.

33. The steam cooking appliance of claim 30, wherein the adapter part is mounted so as to be displaceable in a bearing section formed in the receiving unit essentially in an actuating direction of the water tank.

34. The steam cooking appliance of claim 33, wherein the adapter part includes a slotted guide, and further comprising a spring to apply a spring force essentially in the actuating direction, and a sliding block guided in a retaining clip for engagement in the slotted guide.

35. The steam cooking appliance of claim 16, further comprising a push-push unit configured for removing the water tank from the steam cooking appliance.
